(19) United States
(12) Patent Application Publication
(10) Pub. No.: US 2007/0048702 A1
(43) Pub. Date: Mar. 1, 2007

(54) Immersion-type live-line work training system and method

(76) Inventors: Gil Soo Jang, Seoul (KR); Chang Hyun Park, Seoul (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 11/507,375

(22) Filed: Aug. 21, 2006

(30) Foreign Application Priority Data
Aug. 25, 2005 (KR) 10-2005-0078225

(51) Int. Cl. G09B 19/00

(52) U.S. Cl. 434/224

(57) ABSTRACT

An immersion-type live-line work training system and method. The immersion-type live-line work training system includes a first display device, a motion tracking device, and a computer. The first display device is worn on a trainee's head, and is configured to display a three-dimensional virtual environment for the trainee. a motion tracking device for tracking motion of the trainee to apply the motion to the virtual environment; and the computer executes a program for virtual live-line work, displaying the virtual environment, associated with a power system, on the first display device, and simulates the maintenance and/or repair of the power system in the virtual environment based on tracking signals obtained by the tracking of the motion tracking device.

### BACKGROUND OF THE INVENTION

1. Field of the Invention

The present invention relates generally to an immersion-type live-line work training system and method and, more particularly, to an immersion-type live-line work training system and method for training live-line workers based on virtual reality technology and voice recognition technology.

2. Description of the Related Art

The maintenance and repair of power systems are mostly conducted on live lines. The term ‘live line’ refers to a power supply line through which power is being supplied. In particular, a live line to which high voltage is applied may have the danger of electric shock, and may also cause injury to human bodies due to the radiated-electric field thereof.

Power system maintenance and repair work conducted on live lines is advantageous in that problems with the power system can be solved without power interruptions, but is disadvantageous in that the safety of live-line workers is greatly endangered. Accordingly, training for the live-line workers is a very important issue, and thus it is required to develop an effective training system.

Currently, training for live-line workers is conducted for a predetermined period and is composed of theoretical and practical training, and a qualification for live-line work is granted when all of the eligibility requirements have been satisfied. If only a single brief mistake is made when live-line work is conducted, it may be fatal to the workers, so that training for the workers is not limited only to a finite period, but must be repeated. However, at present, theoretical and practical training for live-line workers are not sufficiently conducted due to the lack of educational institutes and teachers, capable of training live-line workers, and the insufficiency of practice environments.

### SUMMARY OF THE INVENTION

Accordingly, the present invention has been made keeping in mind the above problems occurring in the prior art, and an object of the present invention is to provide an immersion-type live-line work training system and method for training live-line workers based on virtual reality technology and voice recognition technology.

In order to accomplish the above object, the present invention provides an immersion-type live-line work training system, including a first display device worn on a trainee's head, and configured to display a three-dimensional virtual environment for the trainee; a motion tracking device for tracking the motion of the trainee to apply the motion to the virtual environment; and a computer for executing a program for virtual live-line work, displaying the virtual environment, associated with a power system, on the first display device, and simulating the maintenance and/or repair of the power system in the virtual environment based on tracking signals obtained by the tracking of the motion tracking device.

Furthermore, it is preferred that motion tracking device include a first motion tracking device worn on a hand of the trainee and configured to track the motion of the trainee's hand; and a second motion tracking device integrated with the first display device and configured to track the motion of the trainee's head.

Furthermore, it is preferred that the immersion-type live-line work training system further include a second display device for displaying the virtual environment, to which the motion of the trainee is applied, for a trainer.

Furthermore, it is preferred that the immersion-type live-line work training system further include headphones installed in the first display device and configured to transfer voice signals, which are received from the trainer, to the trainee; and a microphone installed in the first display device and configured to transfer voice signals, which are received from the trainee, to the trainer.

Furthermore, it is preferred that the virtual environment include a work electric model and a hand model, apply the motion of the trainee, which is tracked by the motion tracking device, to the hand model, and examine whether contact with the work electric model occurs.

Furthermore, it is preferred that the virtual environment further include live-line work equipment models and that the computer load one or more corresponding live-line work equipment models into the virtual environment in response to voice command signals received through the microphone.

In addition, the present invention provides an immersion-type live-line work training method, including the steps of displaying a three-dimensional virtual environment, associated with a power system, for the trainee through a first display device worn on a trainee's head; tracking the motion of the trainee; and simulating the maintenance and/or repair of the power system while applying the tracked motion of the trainee to the virtual environment.

Furthermore, it is preferred that the method further include the step of displaying a virtual environment, to which the motion of the trainee are applied, for a trainer through a second display device.

Furthermore, it is preferred that the virtual environment include a work electric model and a hand model, and that the method further include the step of applying the tracked motion of the trainee to the hand model, and examining whether contact with the work electric model occurs.

Furthermore, it is preferred that the method further include the steps of receiving voice signals through a microphone integrated with the first display device; and loading one or more live-line work equipment models for the maintenance and/or repair of the power system into the virtual environment in response to the received voice signals.

Accordingly, the immersion-type live-line work training system according to the present invention enables repeated and sufficient training of live-line workers in a limited area based on virtual reality technology and voice recognition technology, thus improving the safety of live-line workers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing an immersion-type live-line work training system according to the present invention;

FIG. 2 is a flowchart illustrating an immersion-type live-line work training method using the immersion-type live-line work training system of FIG. 1;

FIG. 3 is a graphic view showing an example of a virtual environment into which a background model and an electric pole model have been imported;

FIGS. 4A and 4B are graphic views showing examples of live-line work equipment models, in which FIG. 4A is a graphic view showing a three-dimensional transformer model, and FIG. 4B is a graphic view showing a three-dimensional Cutout Switch (COS) model;

FIG. 5 is a graphic view showing an example of a virtual environment for a process of insulating a power line;

FIG. 6 is a graphic view showing an example of a virtual environment for a process of fitting the fuse holder of a COS using a live-line stick;

FIG. 7 is a graphic view showing an example of a virtual environment for a process of installing a COS on an electric pole;

FIG. 8 is a graphic view showing an example of a virtual environment for an electric pole on which the exchange of the COS is completed; and

FIG. 9 is a graphic view showing an example of a virtual environment for a virtual electric on which a temporary COS and a jumper cable have been installed.

### DESCRIPTION OF THE PREFERRED EMBODIMENTS

An immersion-type live-line work training system and method according to the present invention are described in more detail with reference to the accompanying drawings below.

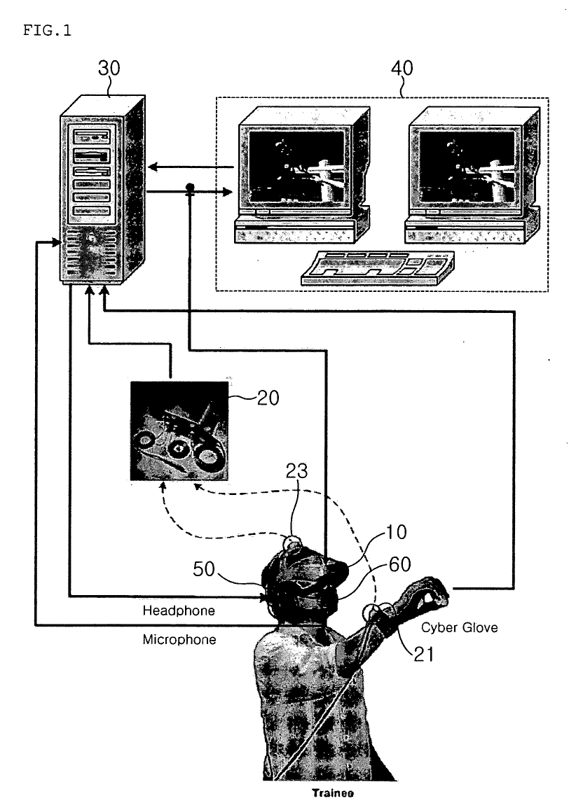

FIG. 1 is a diagram schematically showing an immersion-type live-line work training system according to the present invention. Referring to FIG. 1, the immersion-type live-line work training system includes a first display device 10, a motion tracking device 20, a computer 30, and a second display device 40. The first display device 10 includes a head phone or earphone 50 and a microphone 60. The first display device 10 is worn on the head of a trainee, and displays a three-dimensional virtual reality for the trainee. In this case, the term ‘virtual reality’ refers to one of the new paradigms in the information technology field based on computers. Virtual reality affords indirect experiences in situations that cannot be experienced in reality due to spatial or physical limitations, through interaction with a human sensory system in a virtual environment or cyberspace. Virtual reality technology may be considered as providing a means for generating a three-dimensional virtual environment so that a user experiences it in a manner similar to the real world using the computer 30, and allowing the user to freely manipulate various input/output devices in the virtual environment and make a response to the manipulation.

Virtual reality is basically classified into six types according to the implementation thereof: desktop virtual reality, projected virtual reality, immersive virtual reality, Computer-Assisted Virtual Environment (CAVE) virtual reality, telepresence virtual reality, and augmented-type virtual reality.

Desktop virtual reality is implemented in such a way as to allow a user to interact with a virtual environment delivered on the screen of the computer, and is the most fundamental virtual reality that is used in the industrial design field, the gaming field, the architectural design field, the data visualization field, and the like.

Projected virtual reality is implemented in such a way as to allow the user to combine his or her image with a virtual environment delivered on a large-sized screen of a computer, and is chiefly used for entertainment.

Immersive virtual reality is implemented in such a way as to allow the user to wear a three-dimensional Head Mounted Display (HMD) and thus enter a given computer-generated three-dimensional virtual environment, and to make changes in the surrounding environment according to the user's motion, so that the user feels as if he or she were actually present in the virtual environment.

CAVE virtual reality is implemented in such a way as to provide a small room-shaped virtual environment surrounded by a computer-generated image, and allow a plurality of users to experience the same virtual reality at the same time.

Telepresence virtual reality is implemented in such a way as to allow the user to view or interact with a different location in the real world. Such telepresence virtual reality enables not only interaction for telesurgery but also interaction in dangerous areas, that is, in water, in outer space and in volcanic areas, which cannot be approached in person, using robots, but it can be used only in areas to and from which radio waves can be transmitted and received.

Augmented-type virtual reality is implemented in such a way as to combine the real world and virtual objects. When a special HMD is worn on, the augmented-type virtual reality represents both real objects and hidden objects, which cannot be viewed with the naked eyes. Augmented-type virtual reality has been achieved only at the laboratory level, but is expected to be used for applications such as various maintenance and repair fields and the medical field.

Humans acquire about 70% of information about their surroundings through the sense of vision, so that the sense of vision has the largest influence on virtual reality. Virtual reality is mostly related to a sense of three-dimensional vision and a sense of color. Although a two-dimensional image is projected onto a human's retinas, the reason why it is sensed as three-dimensional space is because physiological and empirical principles act. As physiological factors, there are the focal adjustment of the eye lens (the focal adjustment of an image), convergence movement (inward turning of the eyes), binocular disparity (image difference based on the difference between distances from the left and right eyes to an image), and monocular movement parallax (variation in an image caused by relative movements between an observer and an object). As empirical factors, there are the size of an image focused on the retinas (the perception of an approaching image as increasing in size), linear perspective (the viewing of parallel lines as a single point), definition (clear viewing of a distant image), aerial perspective (decrease in the color saturation and brightness of a distant object), overlapping (the hiding of background images behind the foreground images), and shading (unevenness formed by the shadows of an object). Virtual reality provides the sense of immersion to a user by appropriately using both principles. Such a method is classified as one of two types of visual sensation representation methods. The first type of method is performed by covering the user's environment with a large-sized image space. IMAX and OMNIMAX create environments for audiences through a large-sized screen of 10 m and a dome-type screen, respectively. Recently, Cave Automatic Virtual Environment (CAVE), which connects a plurality of images using a plurality of graphic workstations, has been developed, and has been developed into the Computer Augmented Booth for Image Navigation (CABIN) by the Intelligent Modeling Laboratory (IML) of the University of Tokyo, Japan.

The second type of method is performed using the HMD 10 designed to provide a second strong sense of immersion. The HMD 10 includes a small-sized display installed in front of the eyes and location sensors configured to detect the location and orientation of a head. The operation thereof is performed in such a way as to track the orientation of the head based on information acquired by the spatial location sensors and provide corresponding images to the small-sized display, thus providing the sensation of viewing an extensive image space to a person wearing the HMD.

In the present invention, the first display device 10 is implemented using an HMD based immersion-type virtual reality technology. The HMD 10 is constructed in such a way as to be worn, and two small displays are mounted on the HMD 10. The trainee can view a virtual environment through the HMD 10.

The motion tracking devices 20 track the motion of the trainee to apply the motion to the virtual environment. The motion tracking devices 20 include a first motion tracking device 21 worn on the hand of the trainee and configured to track the motion of the hand of the trainee, and a second motion tracking device 23 integrated with the first display device 10 and configured to track the motion of the head of the trainee.

The first motion tracking device 21 is a nylon glove to which sensors are attached, provides passive access to targets present in the virtual reality displayed through the first display device 10, and enables the representation of corresponding motion in the virtual environment by tracking the motion of the hand of the trainee. That is, the first motion tracking device 21 includes optical fiber sensors (not shown), tracks the location of the trainee, the location of the hand of the trainee, gestures made by the trainee, and the motion angles of the respective fingers of the trainee, and enables the trainee to make a motion of extending an arm toward a target or grasping the target in the virtual environment displayed through the first display device 10.

In the case where the trainee, having worn the HMD 10, turns his or her head, the second motion tracking device 23 detects the rotational value. The rotation of the virtual environment displayed through the first display device 10 is implemented based on the detected rotational value.

The motion tracking devices 20 perform signal processing so that values obtained by the tracking of the first and second motion tracking devices 21 and 23 are applied to the virtual environment displayed through the first display device 10. That is, the motion tracking devices 20 analyze variation in virtual reality, calculated by the computer 30, based on the motion of the trainee's physical body, which are tracked by the first and second motion tracking devices 21 and 23. Representative motion tracking devices 20 include Polhemus's ‘FASTRAK,’ Ascension Technology's ‘Flock of Birds,’ and Logitech's ‘Head Tracker.’ These devices have different input latency times according to whether the tracking of the motion of the trainee is performed in a mechanical method, a magnetic field method, an ultrasonic method or an infrared method. The features of the devices also slightly differ from each other.

In the mechanical method, considerably accurate measurements can be made but limitations on movement are considerably severe. In the ultrasonic method, accurate measurement is difficult because the input delay time is considerably large. The magnetic field method occupies an intermediate position between the two methods. The infrared method has an advantage in that the trainee can freely make motion while products capable of reflecting light (infrared) are attached to his or her body, but has a disadvantage in that it cannot be used in a place to which bright solar light is radiated or which other reflective material exists. The motion tracking device 20 used for the present invention is not limited to any specific method, and may be selectively chosen in consideration of the live-line training process for the trainee, the accuracy of required live-line work, and the range of motion of the trainee required for the live-line work.

The computer 30 executes a program for virtual live-line work so that a virtual environment related to a power system is displayed through the first display device 10, and simulates the maintenance of the power system in the virtual environment based on tracking signals obtained by the tracking of the motion tracking device 20. In this case, it is preferred that the virtual environment implemented using the computer 30 be implemented such that a work electric model and a hand model are included in a virtual environment, the trainee's motion tracked by the motion tracking device 20 is applied to the hand model, and whether the hand model comes into contact with the portions of the work electric model is examined.

The second display device 40 displays the virtual environment to which the trainee's motion is applied through a monitor and a Closed Circuit Television (CCTV) system so that a trainer who teaches live-line work can view it.

The headphone 50 is installed in the first display device 10, and transfers voice signals, provided by the trainer, to the trainee. Furthermore, the microphone 60 is installed in the first display device 10, and transfers voice signals, provided by the trainee, to the trainer. In order to uninterruptedly transmit and receive voice data between the trainee and the trainer, it is preferred that the second display device 40 include a microphone (not shown), and a speaker or headphones (not shown), and that the computer 30 be implemented so as to intermediate the transmission and reception of the voice data between the trainer and the trainee.

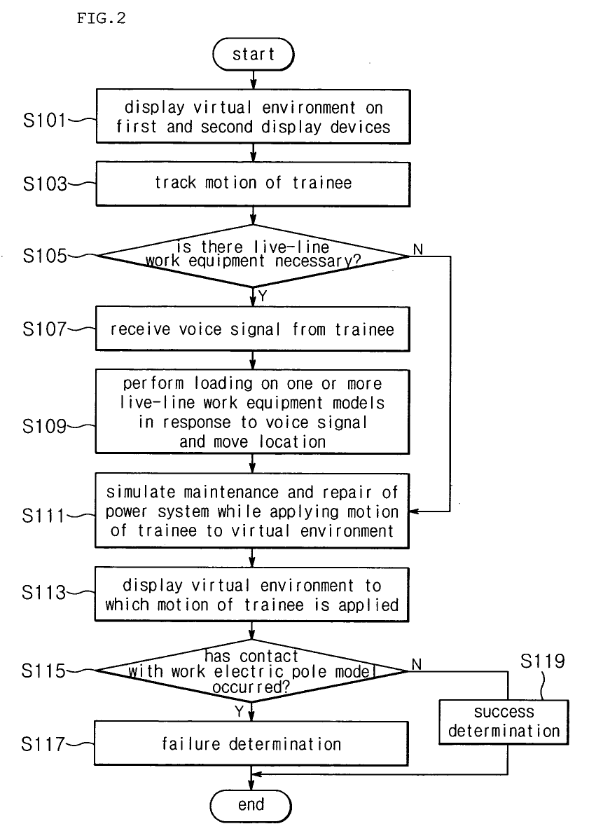

FIG. 2 is a flowchart illustrating an immersion-type live-line work training method using the immersion-type live-line work training system of FIG. 1.

Referring to FIG. 2, the computer 30 executes a program for virtual live-line work so that a virtual environment associated with a power system is displayed on the first display device 10 and the second display device 40 at step S101. The virtual environment, which is implemented using the computer 30 and is associated with the power system, includes a background model, a work electric model, one or more live-line work equipment models, and a hand model.

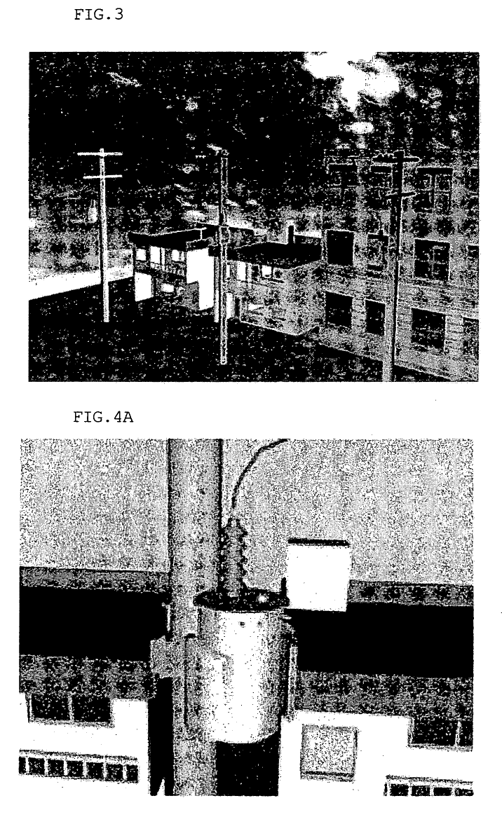

The background model, which is a three-dimensional model for a static surrounding environment, is a background model for a working environment that cannot be grasped or touched using a hand, and is imported into the virtual environment at the time of execution of the program using the computer 30. The work electric model is a model for an electric pole on which actual live-line work for the power system is conducted. Equipment and devices installed on the electric may be touched and moved using the hands. It is preferred that the work electric model be implemented to be imported into the virtual environment at the time of execution of the program using the computer 30. An example in which the background model and the electric model have been imported into the virtual environment is shown in FIG. 3.

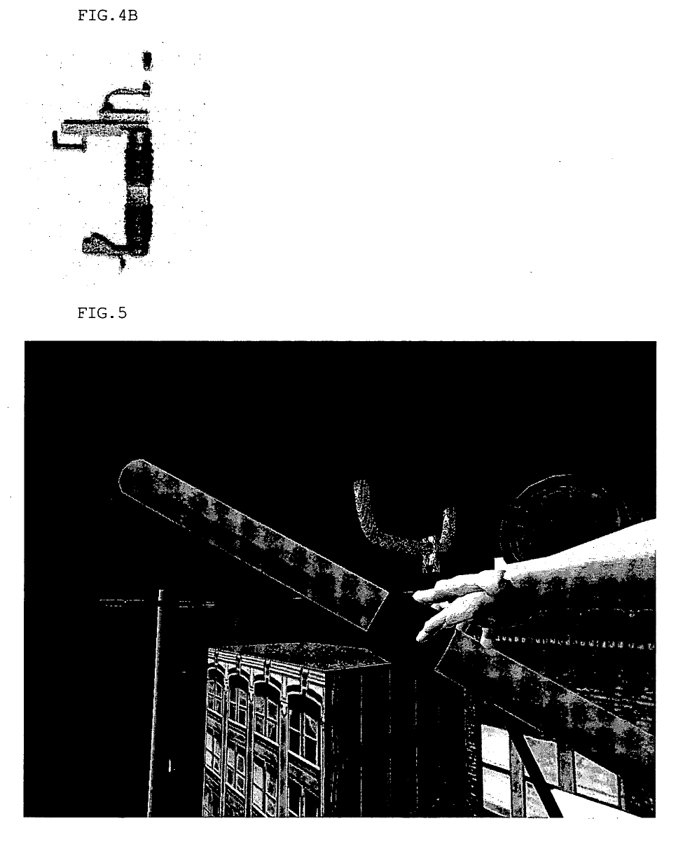

The live-line work equipment models are three-dimensional models for pieces of three-dimensional equipment, such as an insulation cover and a COS, which are necessary for live-line work, and are imported into the virtual environment in response to voice commands from the trainee. FIGS. 4A and 4B are graphic views showing examples of live-line work equipment models, in which FIG. 4A is a graphic view showing a three-dimensional transformer model, and FIG. 4B is a graphic view showing a three-dimensional COS model.

The hand model is a model designed to enact the motion of the trainee's hand, and is imported into the virtual environment at the time of execution of the program using the computer 30.

When the trainee, receiving training for live-line work, wears the first display device 10, the first motion tracking device 21, and the second motion tracking device 23, the first motion tracking device 21 tracks the motion of the trainee's hand, and the second motion tracking device 23 tracks the motion of the trainee's head at step S103. The motion tracking devices 20 perform signal processing so that values obtained by the tracking of the first motion tracking device 21 and the second motion tracking device 23 are applied to the virtual reality displayed on the first display device 10.

If it is determined that pieces of live-line work equipment are necessary while the trainee, receiving training for the live-line work, performs live-line work in the virtual environment displayed on the first display device 10 at step S105, the trainee utters the names of the pieces of necessary live-line work equipment through the microphone 60 and then the computer 30 receives voice signals from the trainee through the microphone 60 at step S107. Furthermore, the computer 30 loads pieces of corresponding live-line work equipment model into the virtual environment, which is displayed on the first display device 10, in response to the received voice signals at step S109. Thereafter, when the trainee directs movement of the location of a live-line work vehicle through the microphone 60 in the case where it is necessary to move the work location during the live-line work, the computer 30 enables the location of the trainee in the virtual environment to be moved in response to the received voice signals at step S109. Actual live-line work is conducted by a driver, who controls the vehicle, and a worker, who conducts work, while standing in a bucket. In this case, the worker, having boarded the bucket, requests the movement of the location from the vehicle driver, and the vehicle driver moves the location in response to the request. In the present invention, the movement of the location of the bucket is achieved using a voice recognition system, so that the live-line work in the virtual environment can approximate actual live-line work.

The trainee simulates the maintenance and repair of the power system on the work electric model using the live-line work equipment models that have been loaded into the virtual environment displayed on the first display device 10 at step S111. That is, when the trainee moves his or her hand or head to conduct the maintenance and repair of the power system on the work electric model, the motion tracking device 20 calculates variation in the virtual environment based on the motion of the trainee and, thereafter, the computer 30 applies values, which are obtained by the calculation of the motion tracking device 20, to the virtual environment and displays the application results on the first and second displays 10 and 40, at step S113.

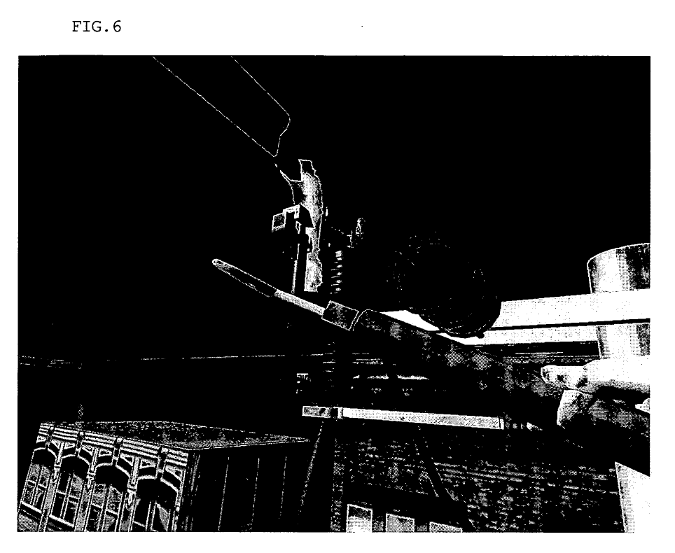

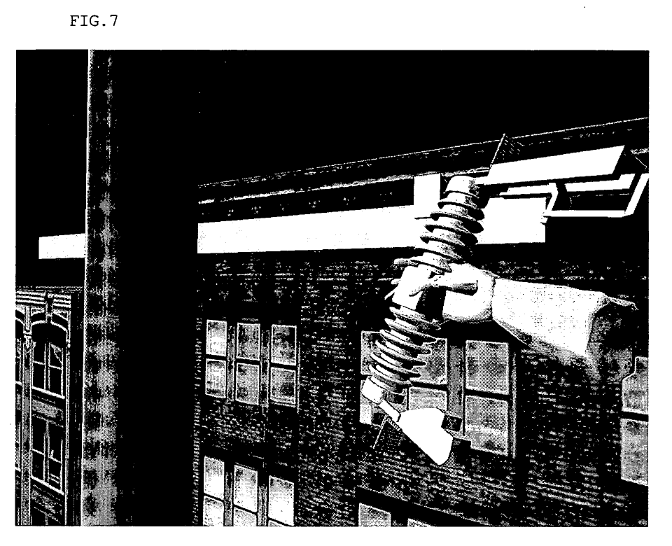

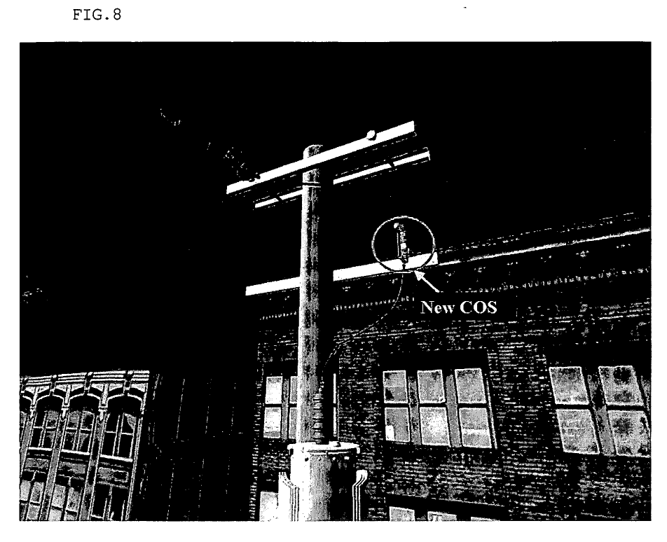

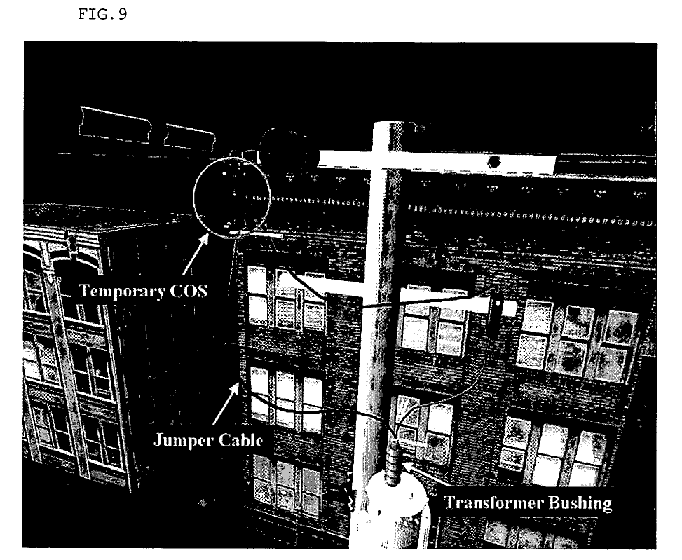

FIGS. 5 to 9 are graphic views showing examples of virtual environments to which the motion of a trainee are applied. FIG. 5 is a graphic view showing an example of a virtual environment for a process of insulating a power line in a virtual environment, and shows a scene in which an insulation cover is imported into the virtual environment by a voice instruction, and the insulation cover is fitted onto an uninsulated power line while care is taken not to bring a hand directly into contact with it. Furthermore, FIG. 6 is a graphic view showing an example of a virtual environment for a process of fitting the fuse holder of a temporary COS using a live-line stick. When a fuse is introduced or removed in the case where work is conducted on a live line, a burn injury will occur if the hand directly comes into contact with the uninsulated power system. Accordingly, the work is conducted using the live-line stick as shown in FIG. 6. Furthermore, FIG. 7 is a graphic view showing an example of a virtual environment for a process of installing a COS on an electric pole, FIG. 8 is a graphic view showing an example of a virtual environment for an electric pole on which the exchange of the COS is completed, and FIG. 9 is a graphic view showing an example of a virtual environment for a virtual electric on which a temporary COS and a jumper cable have been installed.

While training for the live-line work is performed as described above, the computer 30 determines whether contact occurs between the hand model and the uninsulated portions of the work electric model at step S115. In actual live-line work, the live-line worker is aware of a power line insulator, wears gloves and sleeves made of insulating rubber, and conducts live-line work while fitting the power line insulator on the power system. However, if the worker comes into contact with the uninsulated portions of the power system even though he or she is wearing the insulated gloves and sleeves, he or she will be injured by an electric shock. In addition, the electric shock may be fatal if even a small defect exists in the rubber gloves and sleeves. Accordingly, the live-line worker must take care not to directly come into contact with the power system. The present invention introduces the above-described live-line work environment, and determines whether the uninsulated portions and the hand model come into contact with each other while live-line work is conducted in the virtual environment. For this purpose, the work electric model must be configured to be divided into insulated portions and uninsulated portions, and it is preferred that the insulated portions and the uninsulated portions be implemented to be changed according to the work process for which the trainee is being trained. Furthermore, it is preferred that the trainee become highly aware of the uninsulated portions of the work electric model through the conducted live-line work.

If it is determined that the hand model and the uninsulated portions of the work electric model have come into contact with each other, the computer 30 determines that the live-line work conducted by the trainee has failed and then delivers a failure determination to the trainee and the trainer at step S117. If the simulation for the maintenance and repair of the power system is completed without the occurrence of contact between the hand model and the uninsulated portions of the work electric model, the computer 30 delivers a success determination, meaning that the trainee has normally and safely conducted the live-line work, to the trainee and the trainer at step S119. The failure or success determination delivered by the computer 30 may be displayed on the first display device 10 and the second display device 40 or may be transferred through the headphones 50 or a speaker (not shown) in an audible manner. When the hand model directly comes into contact with the work electric model during the live-line work, a phenomenon in which sparks occur is displayed in the virtual environment, so that the failure of the trainee can be realistically indicated.

Accordingly, the immersion-type live-line work training system allows the trainee to repeatedly conduct a live-line work training process in a small space and fully and completely understand live-line work, so that the safety of the live-line worker can be assured.

According to the present invention, the immersion-type live-line work training system allows the trainee to repeatedly train for live-line work, similar to actual situations, in a small space, so that a practice process can be sufficiently experienced before the live-line worker conducts actual live-line work, therefore the present invention can contribute to the safety of live-line workers.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An immersion-type live-line work training system, comprising:
a first display device worn on a trainee's head, and configured to display a three-dimensional virtual environment for the trainee;
a motion tracking device for tracking motion of the trainee to apply the motion to the virtual environment; and
a computer for executing a program for virtual live-line work, displaying the virtual environment, associated with a power system, on the first display device, and simulating maintenance and/or repair of the power system in the virtual environment based on tracking signals obtained by the tracking of the motion tracking device.

2. The immersion-type live-line work training system as set forth in claim 1, wherein the motion tracking device comprises:
a first motion tracking device worn on a hand of the trainee and configured to track motion of the trainee's hand; and
a second motion tracking device integrated with the first display device and configured to track motion of the trainee's head.

3. The immersion-type live-line work training system as set forth in claim 2, further comprising a second display device for displaying the virtual environment, to which the motion of the trainee is applied, for a trainer.

4. The immersion-type live-line work training system as set forth in claim 3, further comprising;
headphones installed in the first display device and configured to transfer voice signals, which are received from the trainer, to the trainee; and
a microphone installed in the first display device and configured to transfer voice signals, which are received from the trainee, to the trainer.

5. The immersion-type live-line work training system as set forth in claim 4, wherein the virtual environment comprises a work electric model and a hand-model, applies the motion of the trainee, which is tracked by the motion tracking device, to the hand model, and examines whether contact with the work electric model occurs.

6. The immersion-type live-line work training system as set forth in claim 5, wherein:
the virtual environment further comprises live-line work equipment models; and
the computer loads one or more corresponding live-line work equipment models into the virtual environment in response to voice command signals received through the microphone.

7. An immersion-type live-line work training method, comprising the steps of:
displaying a three-dimensional virtual environment, associated with a power system, for the trainee through a first display device worn on a trainee's head;
tracking motion of the trainee; and
simulating maintenance and/or repair of the power system while applying the tracked motion of the trainee to the virtual environment.

8. The method as set forth in claim 7, further comprising the step of displaying a virtual environment, to which the motion of the trainee are applied, for a trainer through a second display device.

9. The method as set forth in claim 7, wherein the virtual environment comprises a work electric model and a hand model;
further comprising the step of applying the tracked motion of the trainee to the hand model, and examining whether contact with the work electric model occurs.

10. The method as set forth in claim 7, further comprising the steps of:
receiving voice signals through a microphone integrated with the first display device; and
loading one or more live-line work equipment models for maintenance and/or repair of the power system into the virtual environment in response to the received voice signals.

11. A computer readable recording medium storing a program for executing an immersion-type live-line work training method, comprising the steps of:
displaying a three-dimensional virtual environment associated with a power system for the trainee through a first display device worn on a trainee's head;
tracking motion of the trainee; and
simulating maintenance and/or repair of the power system while applying the tracked motion of the trainee to the virtual environment.

12. The computer readable recording medium as set forth in claim 11, wherein the immersion-type live-line work training method further comprises the step of displaying a virtual environment, to which the motion of the trainee is applied, for a trainer through a second display device.

13. The computer readable recording medium as set forth in claim 11, wherein the virtual environment comprises a work electric model and a hand model;
further comprising the step of applying the tracked motion of the trainee to the hand model, and examining whether contact with the work electric model occurs.

14. The computer readable recording medium as set forth in claim 11, wherein the immersion-type live-line work training method further comprises the steps of:
receiving voice signals through a microphone integrated with the first display device; and
loading one or more live-line work equipment models for maintenance and/or repair of the power system into the virtual environment in response to the received voice signals.
